(19) United States
(12) Patent Application Publication
(10) Pub. No.: US 2023/0262174 A1
(43) Pub. Date: Aug. 17, 2023

(54) IMAGE PROCESSING APPARATUS AND METHOD FOR CONTROLLING DISPLAY OF SETTING HISTORY

(71) Applicant: SHARP KABUSHIKI KAISHA, Osaka (JP)

(72) Inventor: MIYOKO MARUYAMA, Osaka (JP)

(21) Appl. No.: 18/108,102

(22) Filed: Feb. 10, 2023

(30) Foreign Application Priority Data
Feb. 16, 2022 (JP) 2022-022346

(51) Int. Cl. H04N 1/00

(52) U.S. Cl. CPC H04N 1/00395; H04N 1/00517; H04N 1/00477; H04N 1/00482; H04N 1/00413

(57) ABSTRACT

An image processing apparatus includes: a display; a memory configured to store instructions; and one or more processors configured to execute the instructions to: display a first screen displaying a setting history of an executed job and a second screen displaying an operation button for calling a registered job setting; and register the job setting corresponding to the setting history and display the operation button for calling the registered job setting on the second screen, when a job based on the setting history under specific control is executed a predetermined number of times or more in response to a selection performed by a user on the display on the first screen.

### BACKGROUND OF THE INVENTION

### Field of the Invention

The present disclosure relates to an image processing apparatus and the like.

### Description of the Background Art

Some image processing apparatuses, such as multifunction peripherals, store setting values relating to jobs executed in a mode such as a copy mode, a fax mode, and a scan mode, as a setting history.

In recent years, attempts have been made to reduce time and efforts of a user involved in job execution by using stored setting histories. Specifically, an image processing apparatus displays a setting history on a display so that the setting history can be selected by the user. An image processing apparatus that has accepted a selection of a setting history by the user can easily reproduce a job corresponding to the setting history by executing the job in accordance with the setting values associated with the setting history.

Here, the number of setting histories that can be displayed on a display screen displaying setting histories is limited. In general, the display screen limits and hides the oldest setting history when the number of generated setting histories reaches the limit of the number of setting histories that can be displayed. The display screen can display a latest setting history by displaying a newly generated setting history in a space generated by hiding one setting history.

However, in a configuration in which an oldest setting history is hidden, even frequently used setting histories that are useful for the user may be hidden on the display screen, and accordingly, there arises a problem in that a job using such a setting history may not be executed.

In view of this situation, for example, an image processing apparatus that registers a setting of a job corresponding to a selected setting history, when the setting history of the job is selected, as a frequently-used setting is known.

In such an image processing apparatus, a setting of a job corresponding to a setting stored as a setting history is registered as a frequently-used setting (a custom button). The user can then select the custom button to execute the job without performing a job setting again.

However, such an image processing apparatus as described above can only register and call job histories as a list, and may not simply register the job as a job to be frequently executed. In addition, in such an image processing apparatus as described above, the user is required to select a setting history desired to register and then enter a name, a comment, and the like, which is a tedious and time-consuming operation.

An object of the present disclosure is to provide an image processing apparatus and the like that facilitates a procedure for registering a job setting corresponding to a useful setting history and that is capable of improving operability during job execution.

### SUMMARY OF THE INVENTION

To address the above-described problem, an image processing apparatus, includes: a display; a memory configured to store instructions; and one or more processors configured to execute the instructions to: display a first screen displaying a setting history of an executed job and a second screen displaying an operation button for calling a registered job setting; and register the job setting corresponding to the setting history and display the operation button for calling the registered job setting on the second screen, when a job based on the setting history under specific control is executed a predetermined number of times or more in response to a selection performed by a user on the display on the first screen.

A method for controlling display of a setting history according to the present disclosure includes displaying a first screen displaying a setting history of an executed job and a second screen displaying an operation button for calling a registered job setting, and registering the job setting corresponding to the setting history and displaying the operation button for calling the registered job setting on the second screen, when a job based on the setting history under specific control is executed a predetermined number of times or more in response to a selection performed by a user on the display on the first screen.

According to the present disclosure, there is provided an image processing apparatus that facilitates a procedure for registering a job setting corresponding to a useful setting history and that is capable of improving operability during job execution.

### BRIEF DESCRIPTION OF THE DRAWINGS

FIG. 1 is a perspective external view of a multifunction peripheral according to a first embodiment.

FIG. 2 is a diagram illustrating a functional configuration of the multifunction peripheral according to the first embodiment.

FIG. 3A is a diagram illustrating an example of a data configuration of a setting history according to the first embodiment.

FIG. 3B is a diagram illustrating an example of a data configuration of a setting value file according to the first embodiment.

FIG. 4A is a diagram illustrating an example of a data configuration of a pinning management table according to the first embodiment.

FIG. 4B is a diagram illustrating an example of a data configuration of a job program management table according to the first embodiment.

FIG. 5 is a diagram illustrating an example of a data configuration of a job history according to the first embodiment.

FIG. 6 is a flowchart of a processing flow according to the first embodiment.

FIG. 7 is a flowchart of a processing flow according to the first embodiment.

FIG. 8 is a flowchart of a processing flow according to the first embodiment.

FIG. 9 is a flowchart of a processing flow according to the first embodiment.

FIG. 10 is a diagram illustrating an operation example according to the first embodiment.

FIG. 11 is a diagram illustrating an operation example according to the first embodiment.

FIG. 12 is a diagram illustrating an operation example according to the first embodiment.

FIG. 13 is a diagram illustrating an operation example according to the first embodiment.

FIG. 14 is a diagram illustrating an operation example according to the first embodiment.

FIG. 15 is a diagram illustrating an operation example according to the first embodiment.

FIG. 16 is a flowchart of a processing flow according to a second embodiment.

FIG. 17 is a diagram illustrating an operation example according to the second embodiment.

FIG. 18 is a diagram illustrating an operation example according to the second embodiment.

FIG. 19 is a diagram illustrating a functional configuration of a multifunction peripheral according to a third embodiment.

FIG. 20 is a flowchart of a processing flow according to the third embodiment.

FIG. 21 is a flowchart of a processing flow according to the third embodiment.

FIG. 22 is a diagram illustrating an operation example according to the third embodiment.

FIG. 23 is a diagram illustrating an operation example according to the third embodiment.

FIG. 24 is a diagram illustrating an operation example according to the third embodiment.

FIG. 25 is a diagram illustrating a functional configuration of a multifunction peripheral according to a fourth embodiment.

FIG. 26 is a flowchart of a processing flow according to the fourth embodiment.

FIG. 27 is a diagram illustrating an operation example according to the fourth embodiment.

FIG. 28 is a diagram illustrating an operation example according to the fourth embodiment.

FIG. 29 is a flowchart of a processing flow according to a fifth embodiment.

FIG. 30 is a diagram illustrating an operation example according to the fifth embodiment.

### DESCRIPTION OF THE PREFERRED EMBODIMENTS

Embodiments of the present disclosure will be described hereinafter with reference to the accompanying drawings. In the present disclosure, a multifunction peripheral capable of performing, in a single housing, jobs relating to, for example, copying, faxing, image transmission, or the like is described as a form of an image processing apparatus. Note that the embodiments described below are presented as examples for explaining the present disclosure, and therefore, the technical scope thereof as recited in the appended claims is not limited by the following description.

### 1. First Embodiment

A first embodiment relates to display on a setting history screen serving as a first screen, and when a job using a setting history under a specific control has been executed a predetermined number of times or more, a setting of the job corresponding to the setting history is registered and an operation button for calling the registered job setting is displayed on a job program screen as a second screen.

The setting history screen according to the present disclosure is a form of a display screen that displays setting histories generated by execution of jobs in descending order from the newest to the oldest. In the setting history screen, the number of setting histories that can be displayed is limited. When an upper limit of display of the number of generated setting histories is reached, the setting history screen limits and hides an oldest setting history in the setting history screen. The setting history screen can display a latest setting history by displaying a newly generated setting history in a space generated by hiding one setting history.

Here, the specific control according to the present disclosure means control that resists the control to hide the setting history. When the user selects a setting history desired by the user to remain on the setting history screen, for example, the setting history is kept displayed or its display position is fixed regardless of a display position on the setting history screen. Setting histories under the specific control is not deleted from the setting history screen or not hidden, even when the number of generated setting histories reaches the display upper limit.

Such specific control is called, for example, pinning control (simply referred to as “pinning” where appropriate), and a setting history to which such pinning control is applied is highly valuable for the user and the user does not desire to have needlessly deleted (hidden). In the present disclosure, the pinning control is described as a form of the specific control.

Furthermore, a job program according to the present disclosure pertains to a technique of permanently storing a setting associated with a job as a program, and indicates a batch setting in which settings associated with job processing are registered in a batch. In a use case where a regular job is repeatedly executed, the user calls and executes a job program using an operation button so as to set setting values associated with the job in a batch. Accordingly, the number of steps involved in execution of the job may be reduced. The job program according to the present disclosure are described in detail below. In the present disclosure, a display screen displaying the job program is referred to as a job program screen.

### 1.1 Functional Configuration

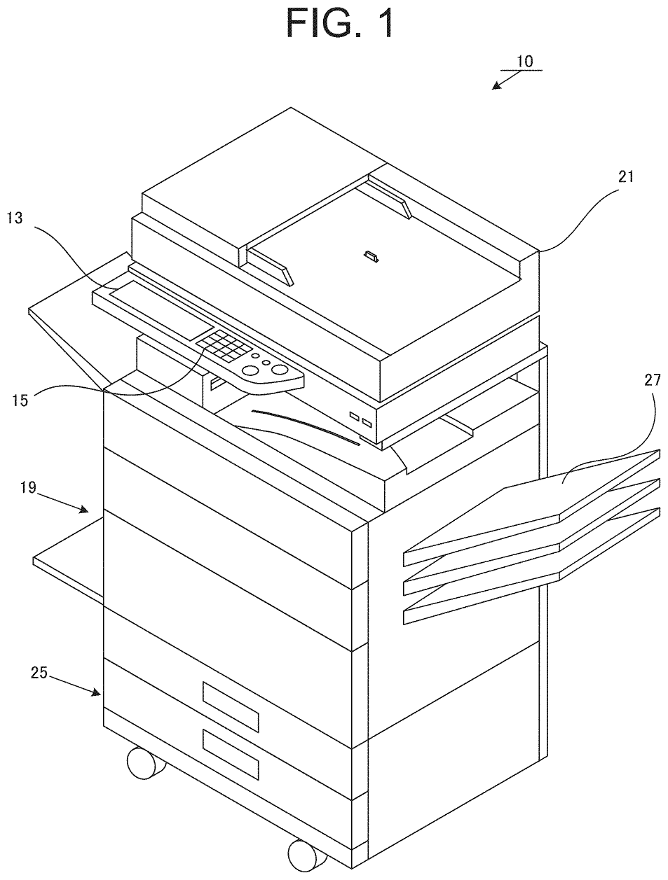

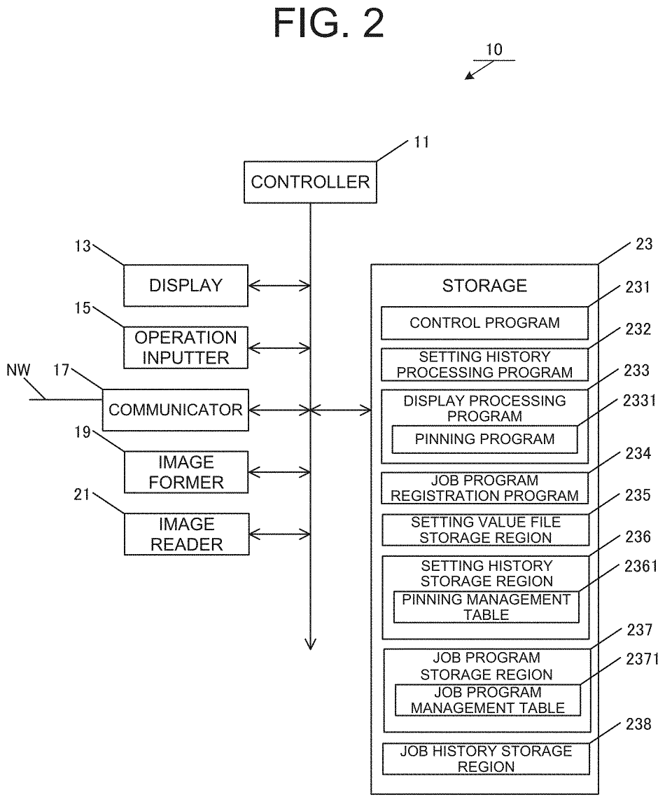

A functional configuration of a multifunction peripheral 10 according to the first embodiment will be described with reference to FIGS. 1 and 2. FIG. 1 is an external perspective view schematically illustrating an entire configuration of the multifunction peripheral 10. FIG. 2 is a diagram illustrating a functional configuration of the multifunction peripheral 10. The multifunction peripheral 10 includes a controller 11, a display 13, an operation inputter 15, a communicator 17, an image former 19, an image reader 21, and a storage 23.

The controller 11 controls the entire multifunction peripheral 10. The controller 11 includes, for example, one or more arithmetic devices (e.g., central processing units (CPUs)). The controller 11 reads and executes various programs stored in the storage 23, thereby implementing functions thereof.

The display 13 displays various types of information for a user, for example. The display 13 can be composed of, for example, a liquid crystal display (LCD) or an organic electro-luminescence (EL) display.

The operation inputter 15 accepts an input of information by the user or the like. The operation inputter 15 may include, for example, hard keys (for example, a numeric keypad) and buttons. Note that the operation inputter 15 may be configured as a touch panel that allows input via the display 13. In this case, for example, a common method such as a resistive method, an infrared method, an electromagnetic induction method, or a capacitive sensing method may be employed as an input method of the touch panel.

The communicator 17 includes either one or both of a wired and wireless interfaces used for performing communication with another device via a network (NW), such as a local area network (LAN), a wide area network (WAN), the Internet, a telephone line, a fax line, or the like.

The image former 19 forms an image based on image data on a sheet serving as a recording medium. The image former 19 feeds a sheet from a paper feeder 25, forms an image based on image data on the sheet, and then discharges the sheet to a paper discharger 27. The image former 19 may be composed of, for example, a laser printer employing an electrophotographic method. In this case, the image former 19 forms an image by using toners supplied from toner cartridges (not illustrated) corresponding to toner colors (e.g., cyan, magenta, yellow, and black).

The image reader 21 scans and reads a document image to generate image data. The image reader 21 may be configured as a scanner device including an image sensor, such as a charge coupled device (CCD) or a contact image sensor (CIS). The configuration of the image reader 21 is not limited as long as the image reader 21 is configured to generate image data by reading a reflected light image from a document image with an image sensor.

The storage 23 stores therein various types of data and various programs required for operation of the multifunction peripheral 10. The storage 23 may be formed of, for example, a storage device, such as a random access memory (RAM), a hard disk drive (HDD), a solid state drive (SSD), or a read only memory (ROM).

In the first embodiment, the storage 23 stores a control program 231, a setting history processing program 232, a display processing program 233, and a job program registration program 234, and ensures a setting value file storage region 235, a setting history storage region 236, a job program storage region 237, and a job history storage region 238.

The control program 231 is read out by the controller 11 when the multifunction peripheral 10 comprehensively controls the entire multifunction peripheral 10. The controller 11 that has read the control program 231 can realize functions performed by the multifunction peripheral 10 as jobs, such as copying, faxing, or image data transmission, by controlling the display 13, the operation inputter 15, the communicator 17, the image former 19, or the image reader 21. Here, the controller 11 can execute various jobs based on setting values included in setting value files associated with setting histories.

The setting history processing program 232 is read by the controller 11 when, for example, acquisition of a setting value relating to execution of a job, generation of a setting history, and various types of processing with respect to the setting history are to be performed. The controller 11 that has read the setting history processing program 232 acquires setting values pertaining to job execution, and generates a setting value file including the setting values. Then, the controller 11 stores the generated setting value file in the setting value file storage region 235. In addition, the controller 11 generates a setting history by associating the setting value file with identification information (for example, a history ID) or the like to identify a job to belong to. The controller 11 then stores the generated setting history in the setting history storage region 236.

The display processing program 233 is read by the controller 11 when the setting history screen serving as the first screen displaying setting histories, the job program screen serving as the second screen displaying job programs, a setting screen for accepting input of various setting values associated with job execution, an execution instruction, or a termination instruction, a basic screen (such as a home screen) displaying the setting screen in a switchable manner, and the like are displayed on the display 13.

Furthermore, the display processing program 233 includes a pinning program 2331. The pinning program 2331 is read by the controller 11 to apply pining control to a setting history. The controller 11 that has read the pinning program 2331 accepts a user's selection of a setting history to which the pinning control is applied, and in addition, manages an application status of the pinning control for the setting history using a pinning management table described below. The controller 11 performs display control to maintain a display state or fix a display position of the setting history to which the pinning control has been applied, on the setting history screen, based on the pinning management table, regardless of the display position on the setting history screen. In principle, the controller 11 does not delete the setting history to which the pinning control has been applied from the setting history screen, but maintains the display until a specific delete instruction is input.

The job program registration program 234 is read by the controller 11 when a job-related setting is registered (stored) as a job program. When the controller 11, which has read the job program registration program 234, executes a job using the setting history to which the pinning control is applied a predetermined number of times, the controller 11 registers job settings corresponding to the setting history as a job program. Furthermore, the controller 11 manages job programs using a job program management table described below.

The setting value file storage region 235 stores a setting value file generated by the controller 11 that has read the setting history processing program 232. Examples of the setting values include a setting value set by the user, such as a color mode, resolution, a format, or color density, or a setting value at beginning of the apparatus held by the apparatus. The controller 11 that has read the control program 231 acquires the setting value file associated with a setting history of an execution target from the setting value file storage region 235 and executes a job based on the setting values included in the setting value file.

The setting history storage region 236 stores a setting history generated by the controller 11 that has read the setting history processing program 232. The setting history stored in the setting history storage region 236 is read out as needed when a display process, a registration process as a job program, or a job using the setting history or the job program is performed.

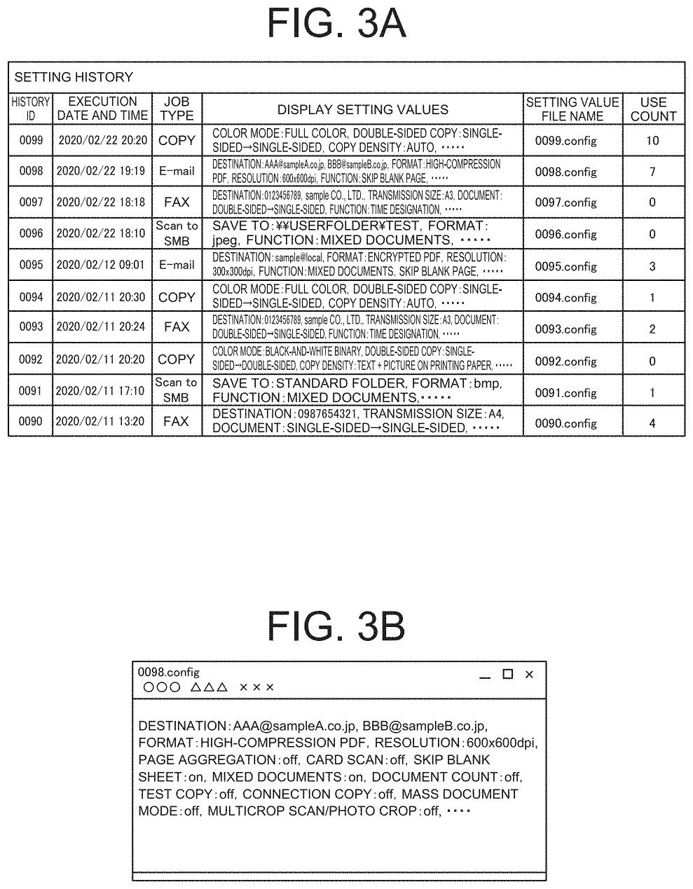

The setting history according to the present disclosure will now be described. FIG. 3A is a table illustrating a configuration example of a data configuration of setting histories stored in the setting history storage region 236. FIG. 3B is a diagram illustrating a configuration example of a data configuration of a setting value file associated with one of the setting histories illustrated in FIG. 3A.

Each of the setting histories illustrated in FIG. 3A includes a history ID, an execution date and time, a job type, display setting values, and a setting value file name, and a use count.

The history ID is identification information for uniquely identifying a setting history. The history ID is assigned to each generated setting history. The history ID may be a serial number as illustrated in FIG. 3A, or may include a certain character string, a symbol, or the like. The execution date and time indicates a date and time of execution of a job. The job type indicates a type of a job to be executed (for example, a copy job, a fax job, an image transmission job (E-mail, scan to SMB, or the like) or the like). The display setting values indicate at least a number of setting values (contents) to be displayed on the setting history screen. The setting value file name represents a file name of a setting value file associated with the setting history. The use count represents the number of times the setting history is used for execution of a job.

For example, a setting history having a history ID “0099” represents a setting history pertaining to a job type “copy” executed at 20:20 on Feb. 22, 2020. The job is a copy job executed based on setting values included in a setting value file “0099.config” and is an example in which setting values (items) of “color mode: full color, double-sided copy: single-sided→single-sided, copy density: automatic, etc.” are set as display setting values to be displayed on the setting history screen. Note that the display setting values set for each history ID are merely examples, and the display setting values displayed on the setting history screen are not limited to those illustrated in FIG. 3A.

Furthermore, the use count “10” indicates that the number of times a job has been executed using the setting history pertaining to the history ID “0099” is 10. Here, as the use count in the setting history, a case where a job is executed using setting values completely the same as setting values included in a stored setting history may be counted as a use count “1” (completely the same), or when only setting values that are comparatively highly likely to be changed (such as a copy count or a color mode) are changed and the other setting values are the same, it may be regarded that the same setting history is used, and the counting may be performed as a use count “1” (partial match). The use count of the setting history may be used as a reference when the setting history to which the pinning control is applied is selected.

FIG. 3B is a diagram illustrating a configuration example of a data configuration of a setting value file “0098.config” associated with a job ID “0098” that is an example of a setting history. For example, the setting value file illustrated in FIG. 3B can be provided as a text file or binary data storing setting values pertaining to job execution, such as “Destination: AAA@sampleA.co.jp, BBB@sampleB.co.jp, Format: high-compression PDF, Resolution: 600×600 dpi, Page Aggregation: off, Card Scan: off, Skip Blank Sheet: on, Mixed Documents: on, Document Count: off, Test Copy: off, Connection Copy: off, Mass Document Mode: off, Multicrop Scan/Photo Crop: off, etc.) In execution of a job based on a setting history, the controller 11 executes the job relating to the setting history using setting values stored in the setting value file. Furthermore, when a process relating to the job is finished, the controller 11 stores the setting values that have been used for the job execution in the setting value file.

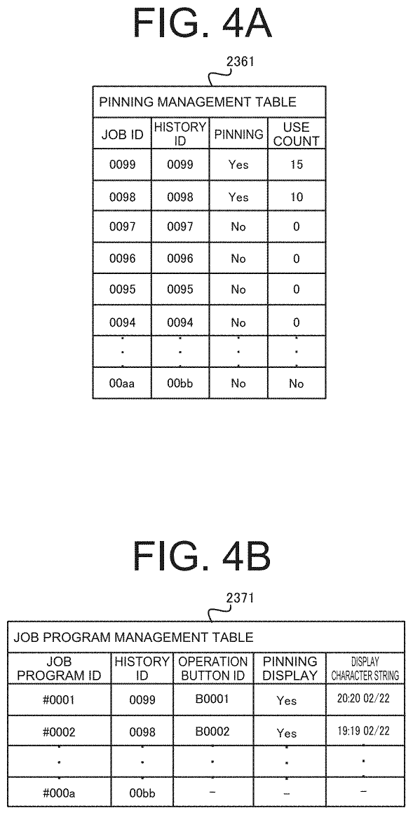

Referring again to FIG. 2, the setting history storage region 236 includes a pinning management table 2361. The pinning management table 2361 manages an application state of the pinning control to a setting history. Here, the pinning management table 2361 according to the present disclosure will be described with reference to FIG. 4A. FIG. 4A is a table explaining an example of a data configuration of the pinning management table 2361.

The pinning management table 2361 illustrated in FIG. 4A includes a job ID, a history ID, a pinning flag, and a use count.

The job ID is an identifier to uniquely identify an executed job. The job ID is generated each time a job is executed. As illustrated in FIG. 4A, the job ID may be a serial number, or may include a certain character string, a symbol, or the like.

As for the history ID, a setting history used when a job is executed is represented by a history ID. History IDs included in the pinning management table 2361 correspond to the history IDs used to identify the setting histories described with reference to FIG. 3A.

The pinning flag is assigned to a setting history to which the pinning control is applied. In FIG. 4A, an example of a case where a pinning flag “Yes” is assigned to a setting history to which the pinning control is applied (e.g., a history ID “0099”) is illustrated.

The use count represents the number of times a setting history to which the pinning control is applied is used in job execution. For example, the use count “15” for the setting history having the history ID “0099” indicates that the number of times the setting history is used is “15” after the pinning control is applied. On the other hand, for example, a setting history having a history ID “0095” has been used “3” times in job execution (refer to FIG. 3A), but the pinning control is not applied, and therefore, the use count in the pinning management table is “0”.

In the first embodiment, when the controller 11, which has read the job program registration program 234, executes a job using a setting history to which the pinning control is applied a predetermined number of times with reference to the pinning management table 2361, the controller 11 registers job settings corresponding to the setting history as a job program. As a use count of a setting history to be registered as a job program (the number of times a job is executed using the setting history), an arbitrary number may be set. For example, assuming that a state in which the use count of the setting history to which the pinning control is applied is 10 or more is determined as a registration condition as a job program, the setting histories corresponding to the history ID “0099” and the history ID “0098” satisfy this condition, and job settings corresponding to these setting histories are registered as job programs.

Referring to FIG. 2 again, the job program storage region 237 stores job settings registered as job programs and a job program management table 2371 that manages the job programs. Here, the job program management table 2371 according to the present disclosure will be described with reference to FIG. 4B. FIG. 4B is a diagram illustrating an example of a data configuration of the job program management table 2371.

The job program management table 2371 illustrated in FIG. 4B includes a job program ID, a history ID, an operation button ID, a pinning display flag, and a display character string.

The job program ID is an identifier for uniquely identifying a registered job program. The job program ID is generated each time a job program is registered. The job program ID may be a serial number including a certain symbol or the like as illustrated in FIG. 4B or may include a character string or the like instead of the symbol.

The history ID is an identifier for identifying a setting history corresponding to settings of a job registered as a job program. The history ID included in the job program management table 2371 corresponds to the history ID for identifying a setting history described with reference to FIG. 3A.

The operation button ID is an identifier for uniquely identifying an operation button assigned to call a registered job program. The operation button identified by the operation button ID corresponds to an operation button disposed on the job program screen described below. When selecting a desired operation button disposed on the job program screen, the user can call a job program assigned to the operation button.

The pinning display flag indicates whether a pinning icon is to be displayed on the operation button disposed on the job program screen. The pinning flag is assigned to a job program corresponding to a setting history to which the pinning control is applied. Note that a pinning display flag “No” is assigned to a job program that does not correspond to a setting history to which the pinning control is applied (such as a job program arbitrarily set by the user).

The display character string is displayed on the operation button disposed on the job program screen. The display character string is generated when the controller 11 which has read the job program registration program 234 extracts a character string included in a setting history to which the pinning control is applied. For example, the job program ID “#0001” (the history ID “0099”) in FIG. 4B is an example in which the controller 11 extracts, from an item of the execution date and time in the setting history corresponding to the history ID “0099”, the string “20:2002/22”. Note that the character string extracted from the setting history by the controller 11 is not limited to the execution date and time. The character string extracted by the controller 11 is not particularly restricted as long as the user can associate and recognize a corresponding setting history with the display character string displayed on the operation button, and may be the history ID itself, or a character string included in the job type or the display setting value.

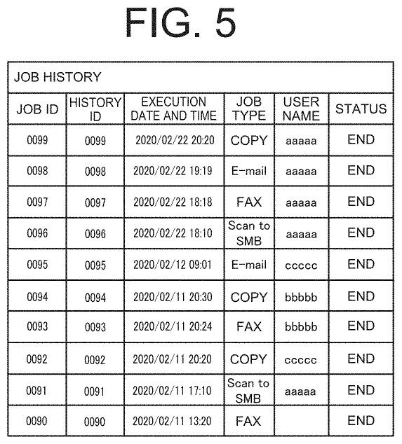

Referring to FIG. 2 again, the job history storage region 238 stores a job execution record as a job history. The job history according to the present disclosure will now be described. FIG. 5 is a table illustrating an example of a data configuration of job histories stored in the job history storage region 238.

Each of the job histories illustrated in FIG. 5 includes a job ID, a history ID, an execution date and time, a job type, a user name, and a status.

The job ID is an identifier for uniquely identifying an executed job, and is the same item and the same content as the item included in the pinning management table 2361 described with reference to FIG. 4A.

The history ID, the execution date and time, and the job type are the same items and the same content as the items included in the setting history illustrated in FIG. 3A. The user name indicates a name of the user who has executed the job. The status indicates a processing status of the job.

For example, a job history for a job ID “0097” relates to a job type “fax” executed at 18:18 on Feb. 22, 2020. Furthermore, the job indicates that an execution instruction has been input by a user of a user name “aaaaa” and a status of the job is “end”.

Note that, unlike the setting history, the job history is information recording an execution history of a job, and a timing of generation of the job history is not restricted. For example, the job history may be generated at any timing, such as before or after execution of a job or before or after generation of a setting history.

### 1.2 Processing Flow

### 1.2.1 Processing Flow of Generation of Setting History

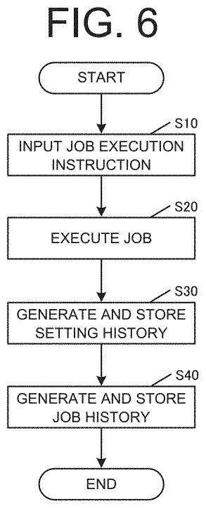

Next, a processing flow of the first embodiment will be described. FIG. 6 is a flowchart schematically illustrating a flow of a process relating to generation of a setting history by the multifunction peripheral 10. The controller 11 generates a setting history by reading and executing the control program 231, the setting history processing program 232, and the like.

The controller 11 receives an input of an instruction for executing a job relating to copying, faxing, image transmission, or the like (step S10). In this case, the user can input the job execution instruction after performing required settings using setting screens corresponding to job types, a setting history screen displayed through a home screen, a job program screen, or the like.

Upon receiving the input of the job execution instruction, the controller 11 executes the job (step S20). Note that the term “job execution” indicates a series of processes executed from reading of a setting history or an input of a setting value to an end of an operation of a job started in response to an input of the job execution instruction under control of one of the job modes including the copying, faxing, image transmission.

Upon execution of the job, the controller 11 acquires the setting values pertaining to the executed job and generates the setting value file storing the setting values. Then, the controller 11 stores the generated setting value file in the setting value file storage region 235. Furthermore, the controller 11 generates a setting history by associating the setting value file with identification information (a history ID) to identify a related job. The controller 11 then stores the generated setting history in the setting history storage region 236 (step S30). Note that the generation and storage of a setting history may be triggered by a reception of the input of the job execution instruction, for example, for start of processing, and therefore, the execution timing of the generation and storage of a setting history is not limited to that described herein.

After the generation of the job history as the job execution history, the controller 11 stores the job history in the job history storage region 238 (step S40) and terminates the process. Note that, although the example in which the job history is generated after the generation and storage of a setting history is illustrated with reference to FIG. 6, the job history may be generated simultaneously with the job execution in step S20 or before the generation and storage of a setting history in step S30, after the input of the job execution instruction in step S10.

1.2.2 Processing Flow from Input of Instruction for Displaying Setting History to Registration as Job Program

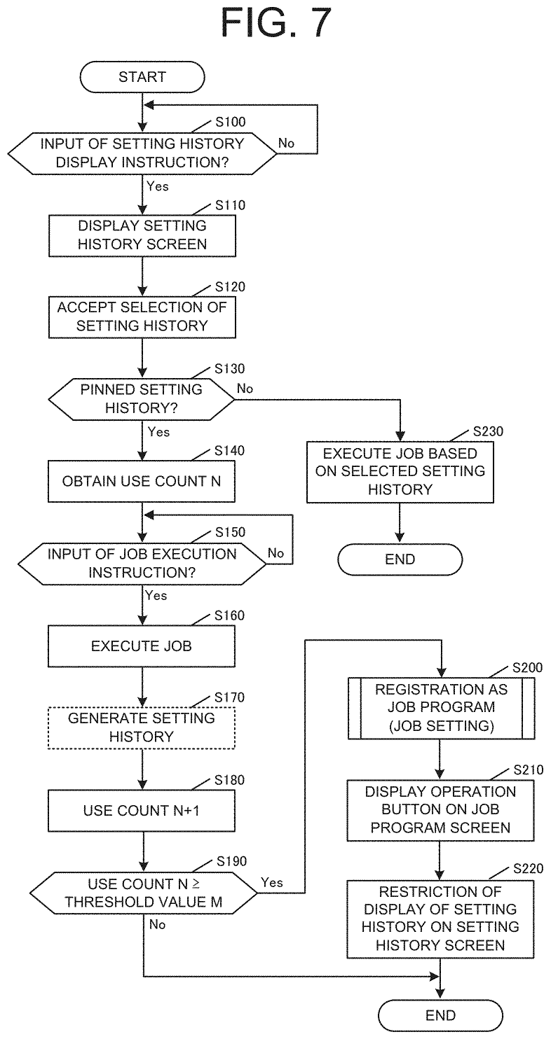

Next, a process from an input of an instruction for displaying a setting history to registration as a job program will be described with reference to a flowchart of FIG. 7. The controller 11 executes the process described with reference to FIG. 7 by reading and executing the control program 231, the setting history processing program 232, the display processing program 233, the job program registration program 234, and the like.

First, the controller 11 determines whether a setting history display instruction has been input by the user (step S100). For example, the user can input the setting history display instruction via the home screen which will be describe later or execution screens (not illustrated) for individual jobs, such as copying, faxing, and image transmission.

When it is determined that a setting history display instruction has been input by the user, the controller 11 displays the setting history screen on the display 13 (step S100; Yes→step S110). On the other hand, when it is determined that an input of a setting history display instruction has not been received, the controller 11 waits until a display instruction is input (step S100; No).

After the setting history screen is displayed, when the user selects a setting history, the controller 11 accepts the selected setting history (step S120).

Subsequently, the controller 11 determines whether pinning control has been applied to the accepted setting history (step S130). In this case, the controller 11 may determine whether pinning control is applied to the selected setting history with reference to the pinning management table 2361 described with reference to FIG. 4A.

When it is determined that the pinning control is applied to the setting history, the controller 11 obtains a use count N indicating the number of times the setting history is used from the pinning management table 2361 (step S130; Yes→step S140). When it is determined that the pinning control is not applied to the setting history, the controller 11 executes a job based on the selected setting history before terminating the process (step S130; No→step S230). In this case, the controller 11 updates the setting history after adding “1” to the use count of the used setting history (refer to FIG. 3A).

Next, the controller 11 determines whether an input of a job execution instruction has been received based on the setting history (step S150).

When it is determined that an input of the job execution instruction has been received, the controller 11 executes a job based on the setting history (step S150; Yes→step S160). On the other hand, when it is determined that an input of a job execution instruction has not been received, the controller 11 waits until an execution instruction is input (step S150; No).

After the job is executed, the controller 11 generates a setting history as needed (step S170). When there is no change in setting values of the used setting history before the job is executed, a setting history is not required to be newly generated, but only the use count is updated, which will be described in a next step.

The controller 11 adds “1” to the use count N obtained in step S140 and updates the use count of the setting history (step S180).

Next, the controller 11 determines whether the use count N obtained in step S180 is equal to or greater than a threshold value M (step S190). Here, the threshold value M is a use count of a setting history to be registered as a job program (the number of times a job is executed using the setting history), and an arbitrary number (value) may be set.

When it is determined that the use count N is equal to or greater than the threshold value M, the controller 11 registers job settings corresponding to the setting history as a job program (step S190; Yes→step S200). Note that the process of registering a job program in step S200 will be described with reference to the next figure. On the other hand, when it is determined that the use count N is smaller than the threshold value M, the controller 11 terminates the process (step S190; No→“end”).

After registering the job program, the controller 11 displays an operation button for calling the registered job program on the job program screen (step S210). Subsequently, the controller 11 hides the setting history corresponding to the registered job program by restricting its display on the setting history screen (step S220), and terminates the process.

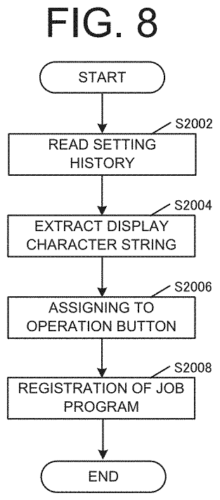

Next, the process of registering a job program performed in step S200 of FIG. 7 will be described with reference to a flowchart of FIG. 8.

The controller 11 reads, from the setting history storage region 236, a setting history for which the use count N is determined to be greater than the threshold value M in step S190 of FIG. 7 (step S2002).

Then, the controller 11 extracts a display character string to be displayed on the operation button disposed on the job program screen from the read setting history (step S2004).

Subsequently, the controller 11 assigns the job program to be registered to the operation button (step S2006).

Finally, the controller 11 registers a display character string extracted in step S2004 and an operation button ID of an operation button to which the job program to be registered is assigned in the job program management table 2371. In addition, the controller 11 stores job settings corresponding to the setting history read in step S2002 as a job program in the job program storage region 237 (step S2008) and terminates the process.

1.2.3 Processing Flow from Job Execution based on Job Program to Display Control of Operation Button on Job Program Screen

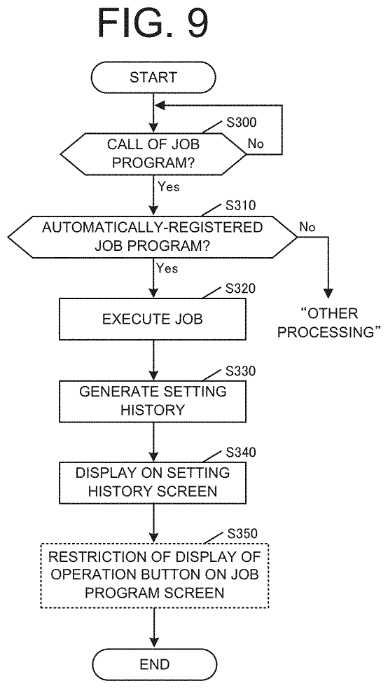

Next, a processing flow from job execution based on a job program to display control of an operation button on the job program screen will be described with reference to a flowchart of FIG. 9. The controller 11 executes the process described with reference to FIG. 9 by reading and executing the control program 231, the setting history processing program 232, the display processing program 233, and the like.

First, the controller 11 determines whether the user has called a job program using the job program screen (step S300). Note that the job program screen can be displayed via the setting history screen or the like. The controller 11 can determine whether a job program corresponding to the operation button has been selected by determining whether an operation button displayed on the job program screen has been selected.

When it is determined that a job program has been called, the controller 11 determines whether the job program has been automatically registered (step S300; Yes→step S310). Here, the term “automatic registration” according to the present disclosure is intended to be a manner in which job settings corresponding to a setting history are automatically registered as a job program without user intervention when use of the setting history satisfies a predetermined condition, as illustrated in FIGS. 7 and 8. Note that the registration of a job program manually performed by the user will be described as another mode. Meanwhile, when it is determined by the controller 11 that a job program has not been called, the controller 11 waits until a job program is called (step S300; No).

When it is determined that a job program has been automatically registered, the controller 11 executes a job in accordance with the selected job program (step S310; Yes→step S320). On the other hand, when it is determined that a job program has not been automatically registered, the controller 11 performs other processing (step S310; No→“other processing”). Here, “other processing” may include, for example, when the job program selected by the user is manually registered, a mode in which the series of processes is terminated after the job is executed according to the job program.

After executing the job in accordance with the job program, the controller 11 generates a setting history based on the job (step S330). The controller 11 then displays the generated setting history on the setting history screen (step S340).

In this case, the controller 11 can also hide the operation button selected by the user by restricting its display on the job program screen (step S350).

### 1.3 Operation Example

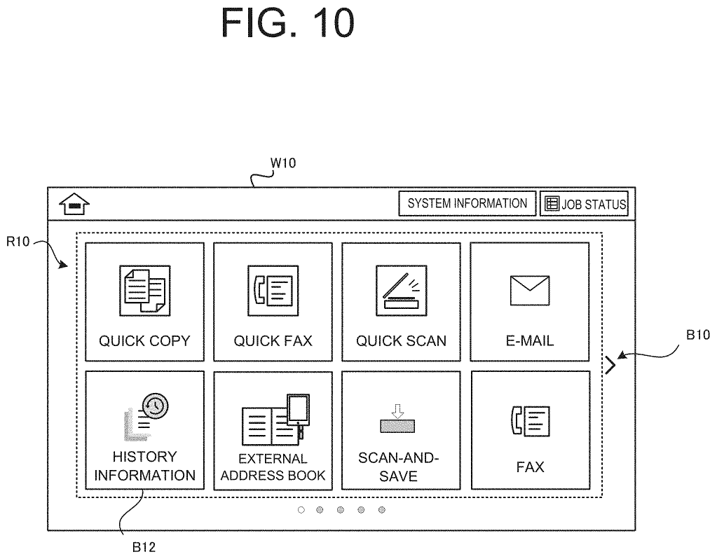

Next, an operation example according to the first embodiment will be described. FIG. 10 is a diagram illustrating an example of a configuration of the home screen W10 which accepts an input of a display instruction on the setting history screen.

The home screen W10 is a basic screen that is displayed on the display 13 when, for example, power is turned on, restoration is performed from a sleep mode, or the like, and accepts an operation input performed by the user. The home screen W10 includes a job function display region R10 and a job function display region switching button B10.

The job function display region R10 displays collection of job function selection buttons that accept selection of corresponding job functions, an input of a display instruction of the setting history screen, and the like. The job function selection buttons have a screen configuration in which each job function and each information are displayed by a graphic, a character, a number, or a symbol.

The job function display region R10 illustrated in FIG. 10 includes, as examples of the selection buttons, the job function selection buttons that accept selection of the job functions, such as a quick copy button, a quick fax button, a quick scan button, an email button, a history information button B12, an external address book button, a scan and save button, a fax button, and the like, and accept an input of a display instruction of the setting history screen.

The job function display region switching button B10 accepts an input of an instruction performed by the user when display content of the job function display region R10 is switched. Upon acceptance of an input of the instruction performed by the user using the job function display region switching button B10, the controller 11 switches the job function selection button to be displayed so as to switch the display content of the job function display region R10.

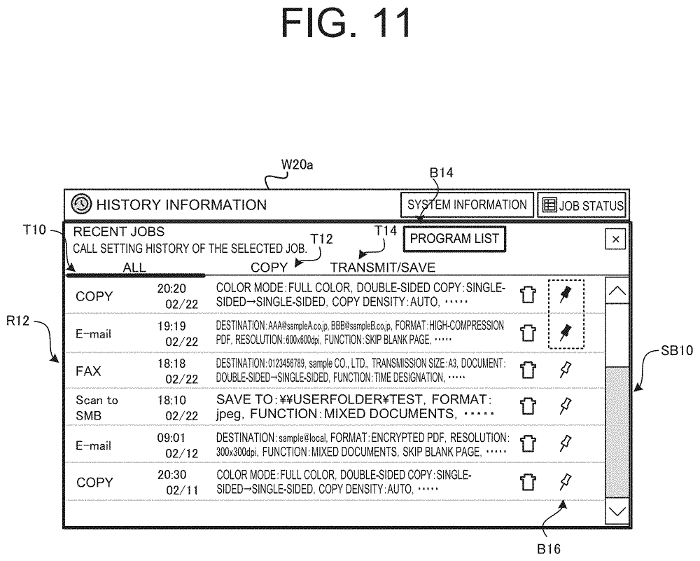

FIG. 11 is a view illustrating a configuration example of a setting history screen W20a displayed by the controller 11 when a history information button B12 of the home screen W10 is selected.

The setting history screen W20a includes a setting history display region R12. The setting history display region R12 displays setting histories corresponding to jobs executed by the user. The setting history display region R12 includes an all-tab T10, a copy tab T12, and a transmit/save tab T14, a program list button B14 serving as an instruction button, and a pinning button B16.

The all-tab T10, the copy tab T12, and the transmit/save tab T14 display setting histories after filtering the setting histories to be displayed according to the job types. A bold underline under the selected tab is displayed to indicate that the tab is selected. FIG. 11 is an example of the setting histories from the topmost setting history (history ID “0099”) to the sixth setting history (history ID “0094”) shown in FIG. 3A, when the all-tab T10 is selected. Other setting histories (a history ID “0093” to a history ID “0090”) that may not be displayed in the setting history display region R12 at once can be displayed in the setting history display region R12 by operating a scroll bar SB10.

A program list button B14 is used to accept a display instruction input for the job program screen W30a described in the next figure. When receiving a selection of the program list button B14 performed by the user, the controller 11 displays the job program screen W30a, described with reference to the next figure, on the display 13. Note that the job program screen W30a includes a setting history button that accepts a display instruction input for the setting history screen W20a. Since both the setting history screen W20a and the job program screen W30a have a display instruction input button to move to the other screen, the user can check an application status of the pinning control performed on a setting history and a registration status of a job program at any time by simply switching screens without canceling an operation mode.

The pinning button B16 accepts a selection of a setting history to which the pinning control is applied. When the user selects the pinning button B16, the controller 11 that detects the selection reads the pinning program 2331 and applies the pinning control to the setting history. When the pinning control is applied to the selected setting history, the display of the pinning button B16 changes to a filled-in state (within a dotted line frame in the figure). In this way, the display form of the pinning button B16 differs before and after the pinning control is applied, so that the user can easily recognize that the pinning control is being applied to the selected setting history. Note that, although not illustrated in FIG. 11, a use count of the setting history illustrated in FIG. 3A may be displayed on the setting history display region R12 so that a selection of a setting history to which the pinning control is applied is facilitated. The user attempting to apply the pinning control can easily select a setting history to which the pinning control is applied, since the user can determine a usage value of the setting history based on the use count of the setting history.

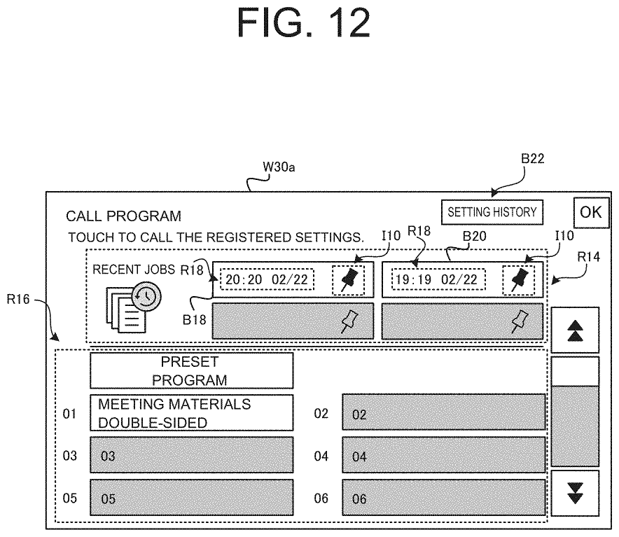

FIG. 12 is a diagram illustrating an example of a configuration of the job program screen W30a displayed by the controller 11 when the program list button B14 is selected on the setting history screen W20a.

The job program screen W30a has a recent job display region R14, a preset program display region R16, and a setting history button B22 as an instruction button.

The recent job display region R14 displays a job program corresponding to the setting history to which the pinning control is applied. Each job program is represented as an operation button for calling the job program, and the user can select a desired operation button to call the job program assigned to the operation button.

For example, the operation button B18 illustrated in FIG. 12 corresponds to the setting history of the history ID “0099” and has an operation button ID “B0001” (refer to FIG. 4B). Furthermore, an operation button B20 corresponds to the setting history of the history ID “0098” and has an operation button ID “B0002” (refer to FIG. 4B). When detecting a selection of the operation button B18 performed by the user, the controller 11 determines that the setting history (the history ID “0099”) associated with a job program ID “#0001” has been selected and executes a job based on job settings corresponding to the setting history. Similarly, when detecting a selection of the operation button B20 performed by the user, the controller 11 determines that the setting history (the history ID “0098”) associated with a job program ID “#0002” has been selected and executes a job based on job settings corresponding to the setting history.

Furthermore, each of the operation buttons B18 and B20 includes a display character string region R18 and a pinning icon I10.

The display character string region R18 is used to display a display character string extracted from the setting history in step S2004 of FIG. 8. Note that, in FIG. 12, an example in which a character string of an execution date and time (“20:20 02/22”) is extracted from the setting history of the history ID “0099” and displayed in the display character string region R18 is illustrated. Furthermore, the pinning icon I10 is displayed as “Yes” when a job program represented by the operation button B18 corresponds to a setting history to which the pinning control is applied, and an inside thereof is filled in. Note that, when a job program represented by the operation button B18 does not correspond to a setting history to which the pinning control is applied, the pinning icon I10 is displayed as “No” and the inside thereof is white.

The content displayed by each of the operation buttons in the recent job display region R14 is determined based on registration content in the job program management table 2371 illustrated in FIG. 4B.

The preset program display region R16 is used to display job programs arbitrarily set by the user. Each of the job programs is represented as an operation button for calling the job programs, and the user can call one of the job programs (“meeting materials, double-sided”, for example) assigned to the operation buttons by selecting a desired one of the operation buttons.

The setting history button B22 receives an input of an instruction for displaying the setting history screen W20a. When receiving a selection of the setting history button B22 performed by the user, the controller 11 displays the setting history screen W20a on the display 13. Since both the job program screen W30a and the setting history screen W20a have a display instruction input button to move to the other screen, the user can check a registration status of a job program, an application status of the pinning control to a setting history, and the like at any time without canceling an operation mode.

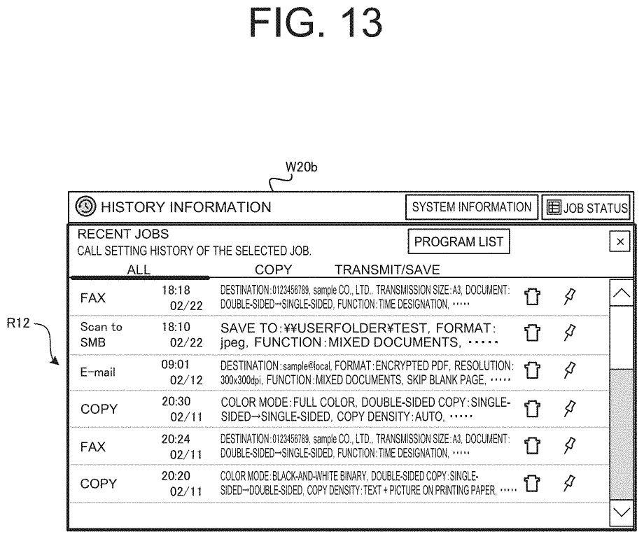

FIG. 13 is a diagram illustrating the setting history screen W20b after a setting history to which the pinning control is applied is registered as a job program corresponding to that setting history.

As described in step S220 of FIG. 7, after the setting history to which the pinning control is applied is registered as a job program corresponding to the setting history, the setting history is restricted in display on the setting history screen W20b and is hidden. In the example shown in FIG. 13, the setting histories of the history IDs “0099” and “0098” to which the pinning control is applied are hidden, and setting histories of history IDs “0093” and “0092” are moved up and displayed in the setting history display region R12 in addition to the remaining setting histories of the history IDs “0097” to “0094”.

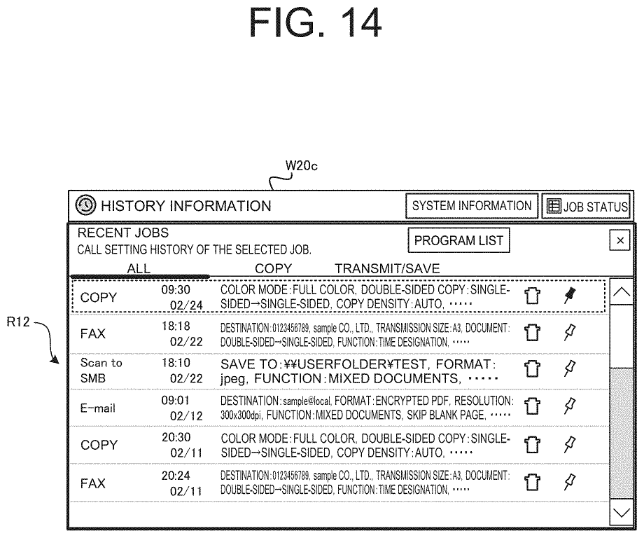

FIG. 14 is a diagram illustrating a setting history screen W20c after a job program corresponding to a setting history to which the pinning control is applied is executed. Note that, in this description, it is assumed that the job is executed based on the job setting corresponding to the history ID “0099” when the operation button B18 is selected on the job program screen W30a illustrated in FIG. 12.

When an instruction for selecting the operation button B18 is accepted on the job program screen W30a, the controller 11 executes a job corresponding to the setting history of the history ID “0099”. When the job is executed, the controller 11 generates a setting history of the executed job and displays the setting history on the setting history screen W20c.

The setting history indicated by the dotted line frame in FIG. 14 is generated based on settings of a job corresponding to the setting history of the history ID “0099”. Since setting values (setting items) included in the newly-generated setting history are the same as those of the history ID “0099”, the newly-generated setting history may be displayed after only an execution date and time is updated (“20:20 02/22”→“09:30 02/24”).

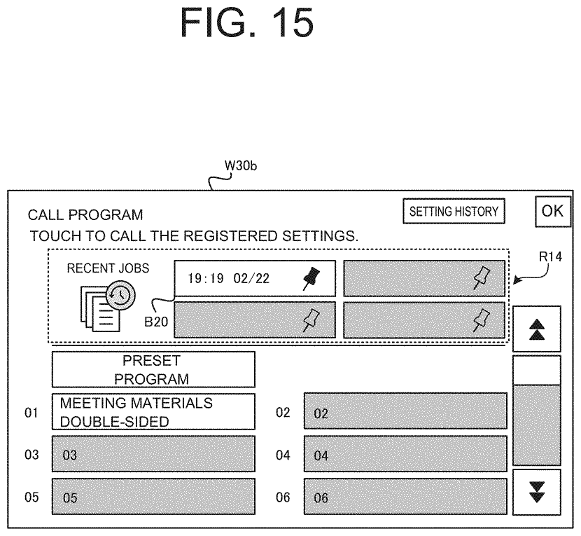

FIG. 15 is a diagram illustrating the job program screen W30b after a job program corresponding to a setting history to which the pinning control is applied is executed. Note that, in a description here, as with FIG. 14, it is assumed that a job is executed based on job settings corresponding to the history ID “0099” when the operation button B18 is selected on the job program screen W30a illustrated in FIG. 12.

As is illustrated in FIG. 14, when an instruction for selecting the operation button B18 is accepted on the job program screen W30a, the controller 11 executes a job corresponding to the setting history of the history ID “0099”. In this case, the controller 11 can also hide the display of the operation button B18, as illustrated in FIG. 15. In the case of the example in FIG. 15, the operation button B18 is hidden, so that only the operation button B20 corresponding to the setting history of the history ID “0098” is displayed in the recent job display region R14 in the job program screen W30b. Note that, when the display of the operation button B18 is to be continued on the job program screen W30a after the job corresponding to the setting history of the history ID “0099” is executed, the setting history shown by the dotted line frame in FIG. 14 may be hidden.

As described above, according to the first embodiment, when a job using a setting history to which the pinning control is applied is executed a predetermined number of times or more, job settings corresponding to the setting history are registered as job programs and an operation button for calling the registered job settings may be displayed on a job program screen. Accordingly, a procedure for registering a job setting corresponding to a useful setting history can be facilitated and operability during job execution can be improved.

At this time, since a name for automatically identifying a job program using a character string included in the setting history is assigned to the operation button, the user may reduce the number of troublesome operation steps involved in the registration of a job program.

Furthermore, according to the first embodiment, since each of the job program screen and the setting history screen has the display instruction input button to move to the other screen, the user can check a registration status of a job program, an application status of the pinning control to a setting history, and the like at any time without canceling an operation mode.

### 2. Second Embodiment

A second embodiment relates to display on a setting history screen, and when a display order of a setting history under a specific control becomes the lowest, a job setting corresponding to the setting history is registered as a job program and an operation button for calling the registered job setting is displayed on a job program screen.

### 2.1 Functional Configuration

A functional configuration of the multifunction peripheral according to the second embodiment may be substantially identical to that of the multifunction peripheral 10 of the first embodiment. Therefore, the multifunction peripheral according to the second embodiment is described as the multifunction peripheral 10, and descriptions of the same configurations as those of the multifunction peripheral 10 are omitted. Note that the determination of the display order of the setting history can be performed by a controller 11 which has read the display processing program 233 described in the first embodiment.

### 2.2 Processing Flow

In a description of a processing flow according to the second embodiment, descriptions of processes that can be performed in the same manner as the first embodiment will be omitted, and a different processing flow will be described.

### 2.2.1 Processing Flow from Determination of Display Order of Setting History to Registration as Job Program on Setting History Screen

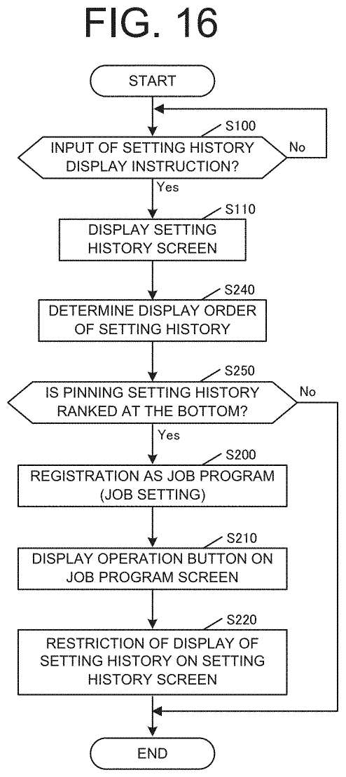

A processing flow according to the second embodiment, from a determination of a display order of a setting history to a registration as a job program on a setting history screen, will be described with reference to a flowchart in FIG. 16. The same step numbers are used to describe the same processes as those described with reference to the flowchart in FIG. 7 of the first embodiment (the processing flow from an input of an instruction for displaying a setting history to a registration as a job program), and descriptions thereof are omitted.

In step S110, when displaying a setting history screen on a display 13, the controller 11 determines a display order of setting histories to be displayed on a setting history screen (step S110→step S240).

In this case, the controller 11 may determine the display order of setting histories within a display range of the setting history screen that can be displayed at one time, or a determination range of the display order may be expanded to a setting history screen displayable when a scroll bar disposed on the setting history screen is operated.

When determining, as a result of the determination of the display order, that the setting history to which the pinning control is applied has the lowest display order, the controller 11 registers job settings corresponding to the setting history as a job program (step S250; Yes→step S200).

After registering the job program, the controller 11 displays an operation button for calling the registered job program on the job program screen (step S210). Subsequently, the controller 11 hides the setting history corresponding to the registered job program by restricting its display on the setting history screen (step S220), and terminates the process.

On the other hand, when it is determined that the display order of the setting history to which the pinning control is applied is not the lowest, the controller 11 terminates the process (step S250; No→“end”).

### 2.3 Operation Example

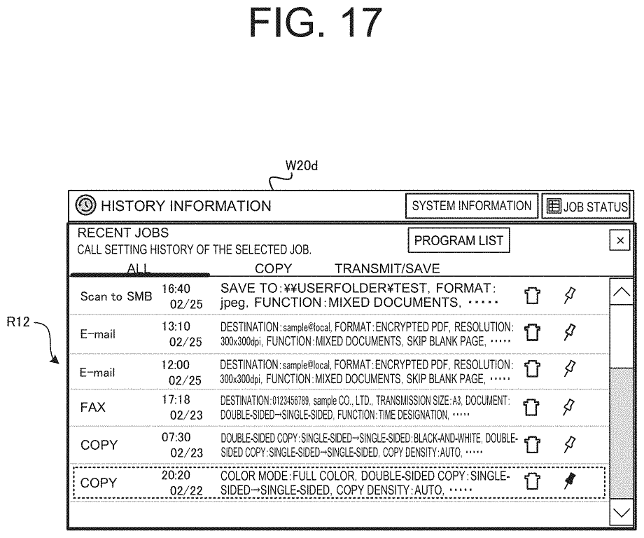

Next, an operation example according to the second embodiment will be described. FIG. 17 is a diagram illustrating an example of an operation for determining a display order of setting histories. The operation example corresponds to the process from step S110 to step S250 of FIG. 16.

The setting history screen W20d illustrated in FIG. 17 represents a state in which a setting history (a history ID “0099”) displayed at the highest level in the setting history screen W20a shown in FIG. 11, etc., is now displayed at the lowest level (within the dotted line in the figure) as a result of generation of a setting history due to execution of another job.

When determining that a display order of the setting history to which the pinning control is applied is the lowest, the controller 11 registers job settings corresponding to the setting history as a job program.

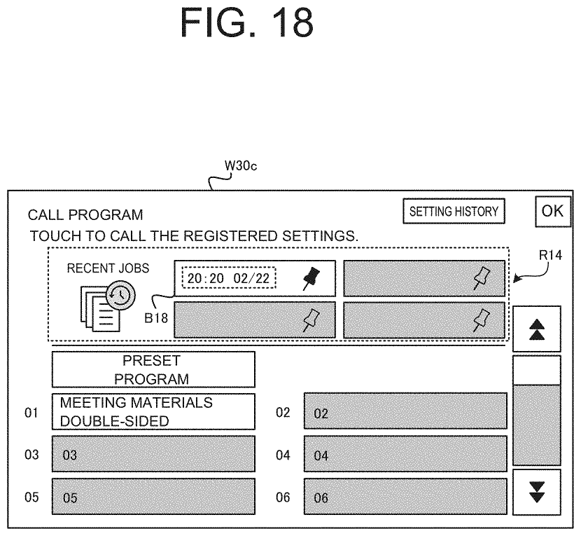

FIG. 18 is a diagram illustrating an example in which settings of the job corresponding to the setting history of the lowest display order are registered as a job program on the setting history screen W20d in FIG. 17. A job program screen W30c illustrated in FIG. 18 may have the same configuration as the job program screen W30a illustrated in FIG. 12.

The registered job program is displayed in a recent job display region R14 as an operation button B18 for calling the job program. Note that, at this time, the setting history corresponding to the registered job program is restricted in display on the setting history screen W20d and is hidden (not shown).

As described above, according to the second embodiment, when the display order on the setting history screen is the lowest, the job settings corresponding to the setting history can be registered as a job program. Accordingly, in addition to the effects of the first embodiment, job settings may be reliably registered as job programs even when the display order of the setting history drops under circumstances that the user is not aware of as a result of the generation of a setting history due to an execution of another job.

### 3. Third Embodiment

According to a third embodiment, a job setting corresponding to a setting history selected by a user is registered on a setting history screen, and an operation button for calling the registered job setting is displayed on a job program screen.

### 3.1 Functional Configuration

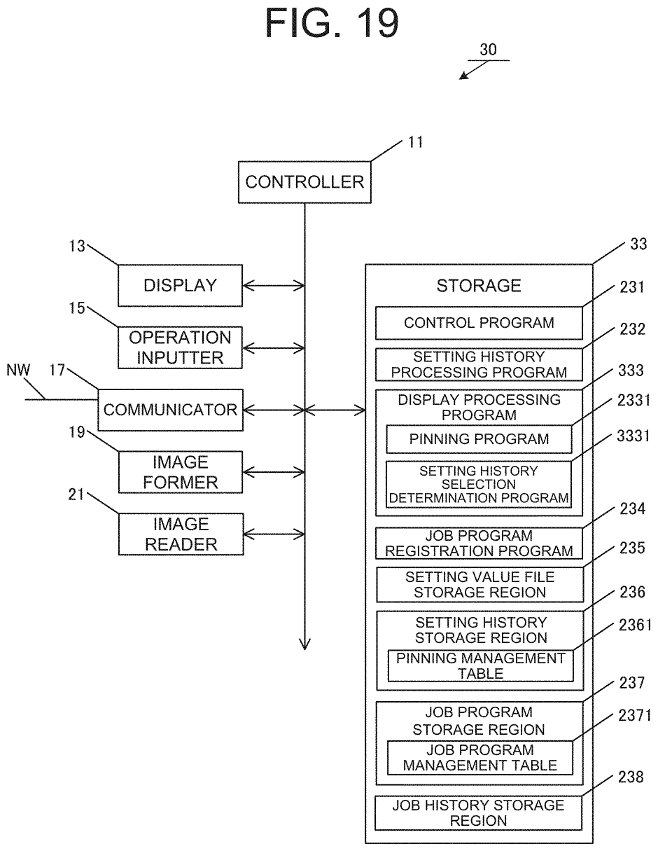

FIG. 19 is a diagram illustrating a functional configuration of a multifunction peripheral 30 according to the third embodiment. The functional configuration of the multifunction peripheral 30 according to the third embodiment may be substantially the same as the functional configuration of the multifunction peripheral 10 according to the first embodiment. Therefore, the same components are marked with the same reference signs and descriptions thereof are omitted.

The multifunction peripheral 30 includes a controller 11, a display 13, an operation inputter 15, a communicator 17, an image former 19, an image reader 21, and a storage 33.

In the third embodiment, the storage 33 stores a control program 231, a setting history processing program 232, a display processing program 333, and a job program registration program 234, and ensures a setting value file storage region 235, a setting history storage region 236, a job program storage region 237, and a job history storage region 238.

The display processing program 333 includes a setting history selection determination program 3331 in addition to a pinning program 2331. When reading the setting history selection determination program 3331, the controller 11 determines whether a selection input of a setting history performed by the user is a request for registration as a job program.

Furthermore, when the controller 11, which has read the job program registration program 234 determines that the input of a selection of a setting history performed by the user corresponds to a request for registering a job program, the controller 11 registers a job setting corresponding to the setting history as a job program.

### 3.2 Processing Flow

3.2.1 Processing Flow from Selection of Setting History to Registration as Job Program on Setting History Screen

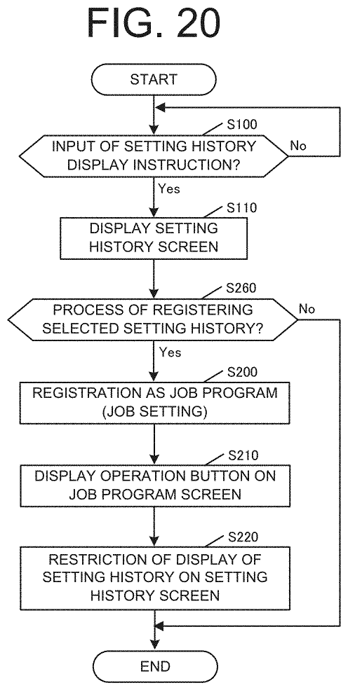

A processing flow according to the third embodiment, from a selection of a setting history to a registration as a job program on a setting history screen, will be described with reference to a flowchart in FIG. 20. Note that the same step numbers are assigned to processes the same as the processing flow described above, and descriptions thereof are omitted. Note that, in this process, the controller 11 executes a process described with reference to FIG. 20 by reading and executing the control program 231, the setting history processing program 232, the display processing program 233, and the like.

In step S110, the controller 11 displays a setting history screen on the display 13. Then, the controller 11 determines whether an operation performed on a pinning button of a setting history corresponds to a request for registration of the setting history as a job program (step S110→step S260).

In this case, for example, the controller 11 can display a menu for accepting a request for registration as a job program as a pull-down menu or the like in response to a selection of the pinning button performed by the user, and determine whether the request for registration as a job program has been issued based on the result of the selection on the menu.

When it is determined that the request for registration as a job program has been accepted, the controller 11 registers a setting of a job corresponding to the setting history, as a job program (step S260; Yes→step S200). On the other hand, when it is determined that the request for registration as a job program has not been accepted, the process is terminated (step S260; No→“end”).

3.2.2 Processing Flow from Job Execution based on Job Program to Display Control of Operation Button on Job Program Screen

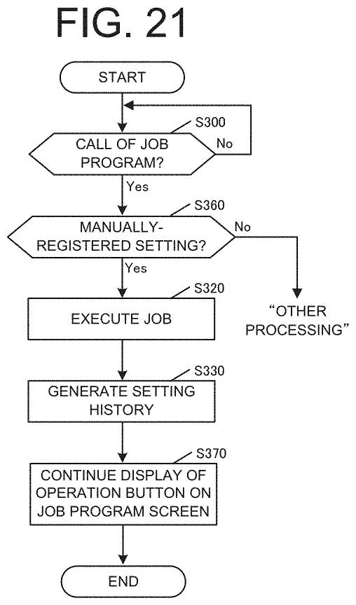

Next, the processing flow from job execution based on a job program to display control of an operation button on the job program screen will be described with reference to a flowchart of FIG. 21. Note that the same step numbers are assigned to processes the same as the processes of the first embodiment described with reference to FIG. 9, and descriptions thereof are omitted.

When it is determined that a job program has been called in step S300, the controller 11 determines whether the job program has been manually registered (step S300; Yes —>step S360). Here, the term “manual registration” according to the present disclosure is intended to be a manner in which job settings corresponding to a setting history are manually registered by a user as a job program as illustrated in FIG. 20. On the other hand, when it is determined by the controller 11 that a job program has not been called, the controller 11 waits until a job program is called (step S300; No).

When it is determined that a job program has been manually registered, the controller 11 executes a job in accordance with the selected job program (step S360; Yes→step S320). On the other hand, when it is determined that a job program has not been manually registered, the controller 11 performs other processing (step S360; No→“other processing”). Note that “other processing” may include, for example, when the job program selected by the user is automatically registered, a mode in which the series of processes is terminated after the job is executed according to the job program.

After executing the job in accordance with the job program, the controller 11 generates a setting history based on the job (step S330). In this case, the controller 11 may or may not display the generated setting history on the setting history screen.

The controller 11 then continues the display of an operation button selected by the user on the job program screen (step S370) and terminates the process.

### 3.3 Operation Example

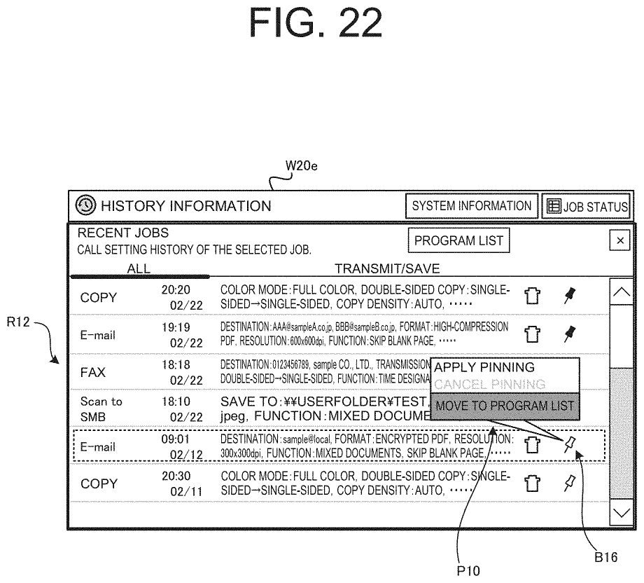

Next, an operation example according to the third embodiment will be described. FIG. 22 is a diagram illustrating an example of an operation for selecting a setting history performed by the user. The operation example corresponds to the process from step S110 to step S260 of FIG. 20.

A setting history screen W20e illustrated in FIG. 22 represents a state in which a setting history (a history ID “0095”) indicated by a dotted line frame in the figure is selected by the user on the setting history screen W20a illustrated in FIG. 11, etc.

When the user selects the pinning button B16 of the setting history desired to be registered as a job program, the controller 11 displays a pull-down menu P10 to accept a registration request as a job program. In this case, the pull-down menu P10 may display a menu or the like that accepts a request for applying the pinning control (“apply pinning”) and a request for cancelling application of the pinning control (“cancel pinning”) in addition to a menu that accepts a request for registering a job setting corresponding to the setting history as a job program (“move to program list”).

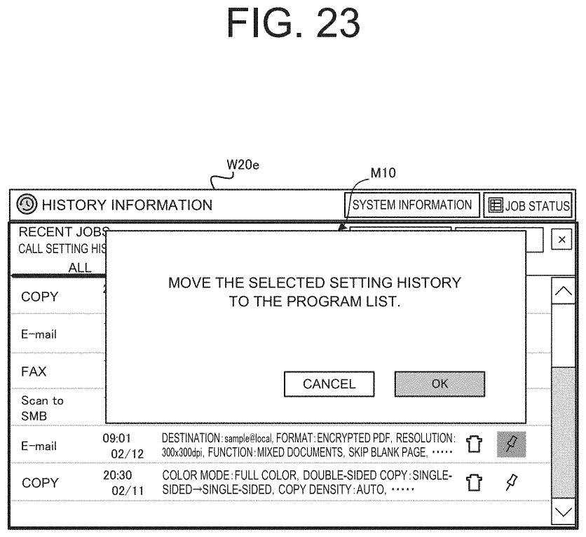

FIG. 23 is a diagram illustrating an example of a configuration of a message screen M10 displayed by the controller 11 when the request for registration as a job program is accepted in the pull-down menu P10. The message screen M10 displays a message indicating that the setting history selected by the user is to be registered as a job program (“Move the selected setting history to the program list”.) The user can check the message and select an OK button in the message screen M10 to register the selected setting history as a job program. Note that, when the registration as a job program is not desired to be performed, a cancel button in the message screen M10 is selected to cancel the registration as a job program.

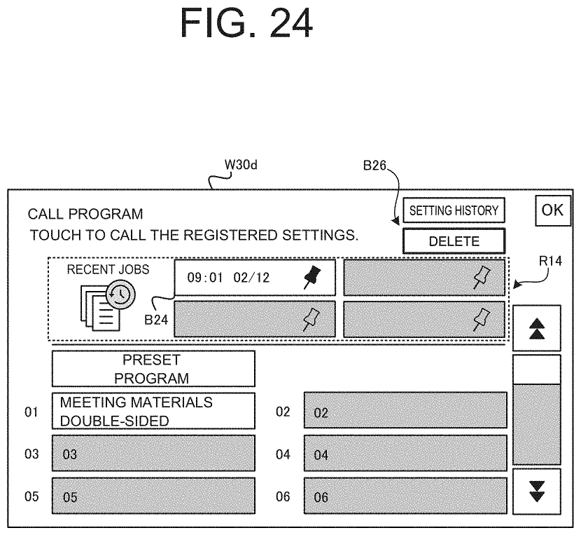

FIG. 24 is a diagram illustrating an example in which job settings corresponding to a setting history selected by the user are registered as a job program on the setting history screen W20e in FIG. 23. A job program screen W30d illustrated in FIG. 24 can have the same configuration as the job program screens W30a to W30c illustrated in FIG. 12, 15, or 18, etc., but differs in that the job program screen W30d includes a delete button B26 that can delete a job program in response to a request for deleting the job program.

The job program registered by a selection performed by the user is displayed in a recent job display region R14 as an operation button B24 for calling the job program. Unlike the first embodiment, the job program registered by the selection of the user is not restricted in its display on the job program screen W30d even after the job using the job program is executed, and display of the operation button B24 is continued (step S370 in FIG. 21).

When the user desires to delete the job program from the job program screen W30d, the user selects the operation button B24 for calling the job program and then selects the delete button B26. As a result, the registration as a job program is canceled and the operation button B24 is hidden on the job program screen W30d.

As described above, according to the third embodiment, settings of a job corresponding to a setting history selected by the user may be registered as a job program. Accordingly, when compared with the first embodiment, for example, settings of a job corresponding to the setting history may be registered as a job program even when the number of times the setting history is executed does not satisfy a predetermined execution count.

Furthermore, according to the third embodiment, a setting history desired to be set as a setting history frequently used by the user may be registered as a job program and may be continuously displayed on the job program screen, and therefore, operability of execution of the job program may be improved.

### 4 Fourth Embodiment

A fourth embodiment has a user authentication function in addition to the configuration of the first embodiment. In the fourth embodiment, a setting history pertaining to a job executed by a user who has been successfully authenticated (hereinafter referred to as an authenticated user) is displayed on a setting history screen so that operability for the authenticated user is further improved.

### 4.1 Functional Configuration

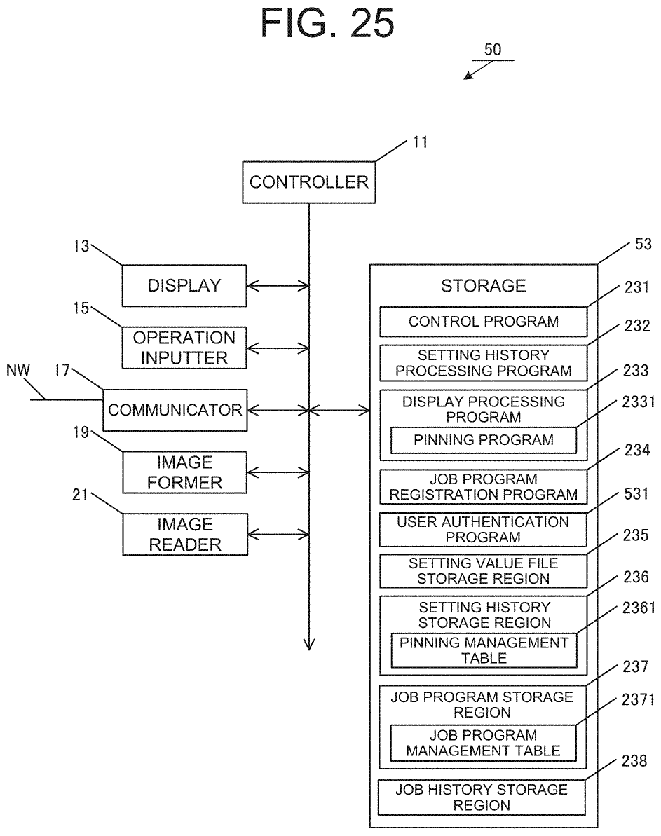

FIG. 25 is a diagram illustrating a functional configuration according to the fourth embodiment. The functional configuration of a multifunction peripheral 50 according to the fourth embodiment may be substantially the same as the functional configuration of the multifunction peripheral 10 according to the first embodiment. Therefore, the same components are marked with the same reference signs and descriptions thereof are omitted.

The multifunction peripheral 50 includes a controller 11, a display 13, an operation inputter 15, a communicator 17, an image former 19, an image reader 21, and a storage 53.

In the fourth embodiment, the storage 53 stores a control program 231, a setting history processing program 232, a display processing program 233, a job program registration program 234, and a user authentication program 531, and ensures a setting value file storage region 235, a setting history storage region 236, a job program storage region 237, and a job history storage region 238.

The user authentication program 531 is read by the controller 11 to authenticate a user who logs into the multifunction peripheral 50. The controller 11 which has read the user authentication program 531 functions as an authenticator, and when an authentication function is activated, the controller 11 performs user authentication based on authentication information received via a user authentication screen or the like described hereinafter. Note that the user authentication may also be performed through, in addition to knowledge authentication, such as a combination of a login user name and a login password, a biometric authentication, such as, fingerprint authentication or face recognition, as well as property authentication using a mobile terminal device or an ID (Identity/Identification Card) card, such as an IC (Integrated Circuit) card or a magnetic card distributed to the user.

In this case, for example, a short-range wireless communication device that can acquire user authentication information from other devices, such as mobile terminals or IC cards via a short-range wireless communication protocol, such as Wi-Fi (registered trademark), Bluetooth (registered trademark), infrared rays, NFC (Near Field Communication), or RFID (Radio-Frequency Identification), or an imaging device, such as a camera, may be provided.

### 4.2 Processing Flow

A flow of the process according to the fourth embodiment can be performed in the same manner as the flow of process described in the first embodiment while a process pertaining to user authentication is added between step S100 and step S120 in FIG. 7.

4.2.1 Flow of Process of Displaying Setting History Screen based on User Authentication Result

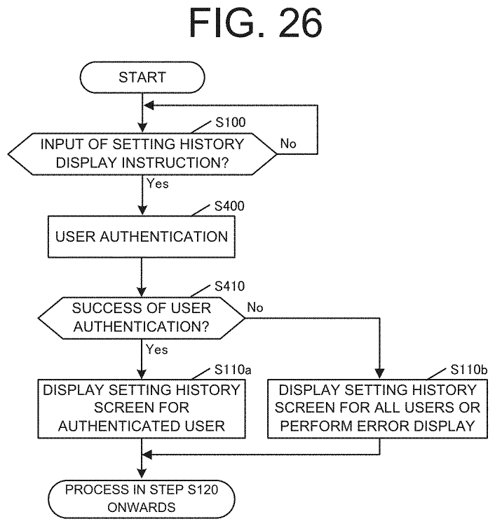

A process associated with the user authentication performed between step S100 and step S120 in FIG. 7 will be described with reference to a flowchart in FIG. 26. Note that the process of user authentication may be performed before step S100 in FIG. 7. In this case, it is sufficient to determine whether the user has been authenticated after step S100.

When it is determined that a setting history display instruction has been input by the user in step S100, the controller 11 displays a user authentication screen and performs user authentication (step S100; Yes→step S400). On the other hand, when the user does not input a setting history display instruction, the controller 11 continues to display a screen being displayed (for example, a home screen or the like) (step S100; No).

When it is determined that the user authentication is successfully performed as a result of the user authentication, the controller 11 displays a setting history pertaining to a job executed by the authenticated user on the setting history screen (step S410; Yes→step S110a). On the other hand, when it is determined that the user authentication has failed, the controller 11 displays setting histories pertaining to jobs executed by all users on the setting history screen or performs error display on the display 13 (step S410; No→step S110b).

After displaying the setting history screen in step S110a or step S110b, the controller 11 executes the process in step S120 and subsequent processes.

### 4.3 Operation Example

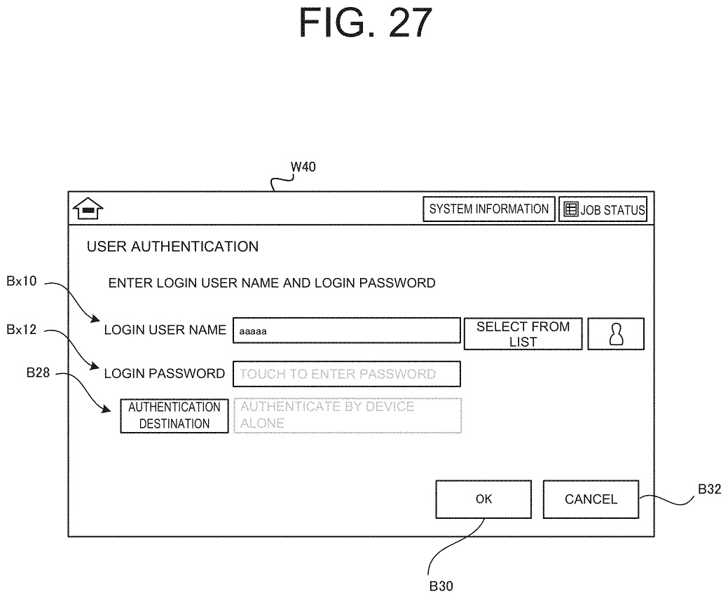

Next, an operation example according to the fourth embodiment will be described. FIG. 27 is a diagram illustrating an example of a configuration of a user authentication screen W40 displayed in step S400 of FIG. 26.

The user authentication screen W40 includes a user name input box Bx10, a password input box Bx12, an authentication destination selection button B28, an OK button B30, and a cancel button B32.

The user name input box Bx10 accepts an input of a user name of a user requesting user authentication to the multifunction peripheral 50.

The password input box Bx12 accepts an input of a password associated with the user name of the user requesting the user authentication to the multifunction peripheral 50.

The authentication destination selection button B28 accepts a selection of a user authentication destination. In FIG. 27, an apparatus (the multifunction peripheral 50) is solely selected as the user authentication destination. Note that, when the user is managed by another device, such as a management server, via a network (NW), a name of the device or positional information of the device on the network (for example, an IP address) can be selected.

The OK button B30 accepts an authentication operation performed by the user. The cancel button B32 accepts cancel of the authentication operation performed by the user.

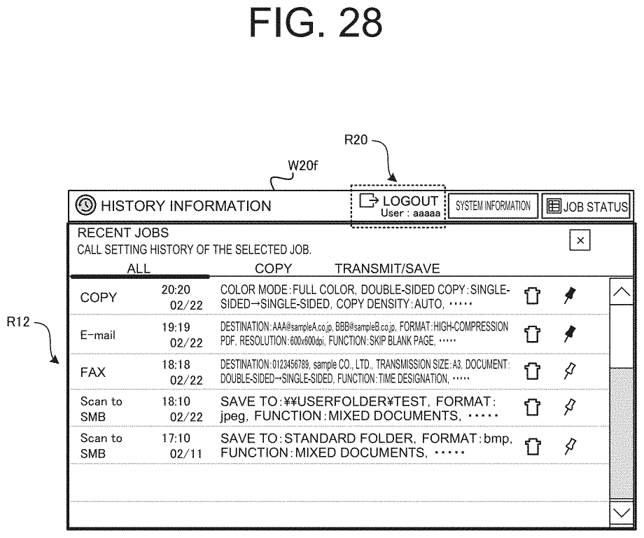

FIG. 28 is a diagram illustrating an example of a configuration of a setting history screen W20f which displays a setting history executed by the user of a user name “aaaaa” who has been successfully authenticated.

The setting history screen W20f illustrated in FIG. 28 has an authenticated user name display region R20 that displays the user name “aaaaa” of the user who has been successfully authenticated, and the setting history display region R12 only displays the setting histories of jobs executed by the user with the user name “aaaaa” (history IDs “0099” to “0096” and a history ID“0091”) (refer to FIG. 3A and 5).

As described above, according to the fourth embodiment, since a setting history pertaining to a job executed by an authenticated user is displayed on the setting history screen, the time and effort involved for the authenticated user may be reduced when the pinning control is applied to the setting history, when registration as a job program is performed, or when a job is executed using the setting history.

### 5 Fifth Embodiment

In a fifth embodiment, when the setting history selected by the user according to the first embodiment is a setting history pertaining to a transmission job to which pinning control is applied, the user is inquired whether the setting history may be registered as a job program.

### 5.1 Functional Configuration

A functional configuration according to the fifth embodiment may be the same as that of the multifunction peripheral 10 according to the first embodiment. Therefore, the multifunction peripheral according to the fifth embodiment is described as the multifunction peripheral 10, and descriptions of the same configurations as those of the multifunction peripheral 10 are omitted. Note that an inquiry as to whether registration as a job program can be performed by the controller 11, which has read the display processing program 233 described in the first embodiment.

### 5.2 Processing Flow

### 5.2.1 Process for Inquiring Whether Registration as Job Program can be Performed

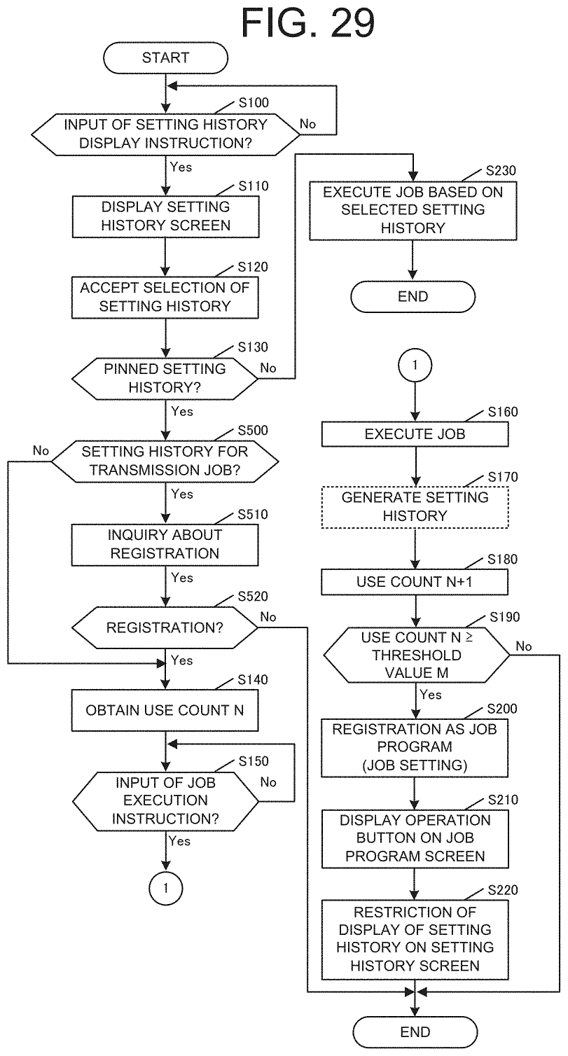

A process of inquiring whether registration as a job program is performed will be described with reference to a flowchart of FIG. 29. The same step numbers are used to describe the same processes as those described with reference to the flowchart in FIG. 7 of the first embodiment (the processing flow from an input of an instruction for displaying a setting history to a registration as a job program), and descriptions thereof are omitted. In FIG. 29, a process of inquiring whether registration as a job program is performed is performed between step S130 and step S140 in FIG. 7.

When determining that the pinning control is applied to the setting history, the controller 11 determines whether the setting history is associated with a transmission job (step S130; Yes→step S500).

When determining that the setting history relates to a transmission job, the controller 11 inquires the user whether job settings corresponding to the setting history are registered as a job program (step S500; Yes→step S510). On the other hand, when determining that the setting history does not relate to a transmission job, the controller 11 proceeds to step S140 (step S500; No→step S140).

As a result of the inquiry to the user, when it is determined that the user has allowed registration as a job program, the controller 11 executes the process in step S140 (step S520; Yes→step S140). On the other hand, when it is determined that the user has not allowed registration as a job program, the controller 11 terminates the process (step S520; No→“end”).

### 5.3 Operation Example

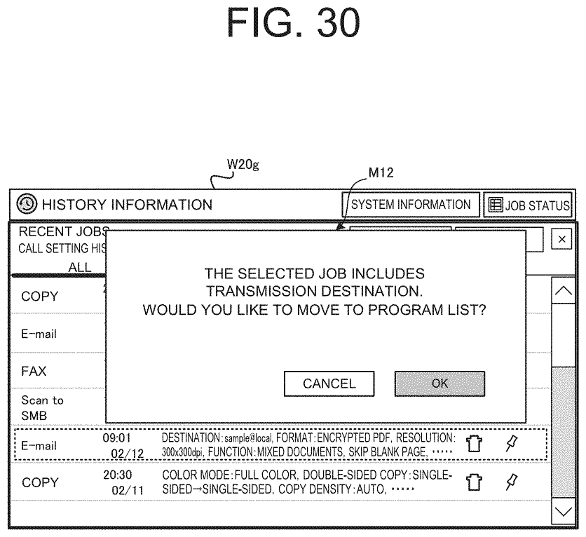

Next, an operation example according to the fifth embodiment will be described. FIG. 30 is a diagram illustrating an example of a configuration of a setting history screen W20g displaying a message screen M12 for inquiring the user whether job settings corresponding to a setting history are registered as a job program.

The message screen M12 displays a message (“The selected job includes transmission destination. Would you like to move to program list?”) for inquiring whether to register the job settings corresponding to the setting history as a job program. The user checks the message and selects an OK button in the message screen M12 to register the selected setting history as a job program. Note that, when the registration as a job program is not desired to be performed, a cancel button in the message screen M12 is selected to cancel the registration as a job program.

As described above, according to the fifth embodiment, by inquiring the user whether a setting history relating to a transmission job using destination information, such as an email address, a fax number, or a telephone number is to be registered as a job program, the destination information not to be externally leaked is prevented from being unexpectedly registered as a job program and a certain level of security may be ensured.

The present disclosure is not limited to the embodiments described above, and various modifications may be made. That is, the technical scope of the present disclosure also includes an embodiment obtained by combining technical measures modified as appropriate without departing from the scope of the present disclosure.

Furthermore, although some parts of the above embodiments have been described separately for convenience of explanation, it is needless to say that the embodiments may be combined within a technically possible range and implemented.

In addition, the program to be operated on each of the devices in the embodiments is a program that controls the CPU or the like (i.e., a program which makes a computer function) so as to implement the functions of the above-described embodiments. The information handled by the devices is temporarily accumulated in a temporary storage device (for example, a RAM) during processing of the information, and then, is stored in various storage devices such as a read-only memory (ROM) and an HDD, and is read, modified, and written by the CPU as necessary.

A recording medium used for storing the program may be any one of a semiconductor medium (for example, a ROM, a non-volatile memory card, or the like), an optical recording medium or a magnetooptical recording medium (for example, a digital versatile disc (DVD), a magnetooptical disc (MO), a mini disc (MD), a compact disc (CD), a Blu-ray (registered trademark) disc (BD), or the like), and a magnetic recording medium (for example, a magnetic tape, a flexible disk, or the like). The functions of the present disclosure may also be realized not only by executing the loaded programs, but also processing in cooperation with the operating system, other application programs, or the like in accordance with the instructions of the programs.

Furthermore, when the program is to be distributed to the market, the program may be stored in a portable recording medium for distribution or transferred to a server computer connected via a network such as the Internet. In this case, a storage device of the server computer is also included in the present disclosure as a matter of course.

What is claimed is:

1. An image processing apparatus, comprising:
a display;
a memory configured to store instructions; and
one or more processors configured to execute the instructions to:
display a first screen displaying a setting history of an executed job and a second screen displaying an operation button for calling a registered job setting; and
register the job setting corresponding to the setting history and display the operation button for calling the registered job setting on the second screen, when a job based on the setting history under specific control is executed a predetermined number of times or more in response to a selection performed by a user on the display on the first screen.

2. The image processing apparatus according to claim 1, wherein the one or more processors are configured to execute, as the specific control, control of resisting control of hiding the display of the setting history on the first screen.

3. The image processing apparatus according to claim 2, wherein the resisting control includes control of maintaining a display state of the setting history irrespective of a display position on the first screen or control of fixing the display position on the first screen.

4. The image processing apparatus according to claim 1, wherein the one or more processors, when the registered job setting is selected using the operation button, are configured to execute a job based on the job setting and displays the setting history of the executed job on the first screen.

5. The image processing apparatus according to claim 1, wherein the one or more processors, when a display order of the setting history under the specific control is the lowest on the first screen, are configured to register the job setting corresponding to the setting history and display the operation button for calling the job setting on the second screen.

6. The image processing apparatus according to claim 1, wherein the one or more processors, when a selection of the setting history performed by the user is accepted on the first screen, are configured to register the job setting corresponding to the setting history and displays the operation button for calling the job setting on the second screen.

7. The image processing apparatus according to claim 6, wherein the one or more processors, when the job setting registered in response to a selection by the user is selected using the operation button, are configured to execute a job based on the job setting and continues the display of the operation button on the second screen.

8. The image processing apparatus according to claim 6, wherein the one or more processors are configured to cancel registration of the job setting when receiving a deletion request from the user.

9. The image processing apparatus according to claim 1, wherein the first screen includes an instruction button for accepting an instruction of screen transition to the second screen.

10. The image processing apparatus according to claim 1, wherein the second screen includes an instruction button for accepting an instruction of screen transition to the first screen.

11. The image processing apparatus according to claim 1, wherein
the one or more processors are further configured to authenticate a user and display the setting history associated with a job executed by the successfully-authenticated user on the first screen.

12. The image processing apparatus according to claim 1, wherein
when the executed job is a job for transmitting image data to a transmission destination, the one or more processors are configured to make an inquiry as to whether the job setting is to be registered to the user in registration of the job setting corresponding to the setting history.

13. A method for controlling display of a setting history, the method comprising:
displaying a first screen displaying a setting history of an executed job and a second screen displaying an operation button for calling a registered job setting; and
registering the job setting corresponding to the setting history and displaying the operation button for calling the registered job setting on the second screen, when a job based on the setting history under specific control is executed a predetermined number of times or more in response to a selection performed by a user on the display on the first screen.
